(19) United States
(12) Patent Application Publication
(10) Pub. No.: US 2006/0158900 A1
(43) Pub. Date: Jul. 20, 2006

(54) Diffusing plate with improved brightness, and backlight assembly and display device including the same

(75) Inventors: Jin-Sung Choi, Gyeonggi-do (KR); Jin-Mi Jung, Seoul (KR); Dong-Hoon Kim, Seoul (KR); Jeong-Hwan Lee, Gyeonggi-do (KR); Jheen-Hyeok Park, Gyeonggi-do (KR)

Correspondence Address: MacPherson Kwok Chen & Heid LLP, Suite 226, 1762 Technology Drive, San Jose, CA, 95110, US

(73) Assignee: SAMSUNG ELECTRONICS CO., LTD., Suwon-si (KR)

(21) Appl. No.: 11/305,583

(22) Filed: Dec. 16, 2005

(30) Foreign Application Priority Data
Dec. 17, 2004 (KR) 10-2004-0108165

(51) Int. Cl. F21V 7/04

(52) U.S. Cl. 362/606

(57) ABSTRACT

A diffusing plate provides with an improved brightness, as well as a backlight assembly. A diffusing plate includes an organic pigment so as to activate the incident light thereby increasing the transmissivity of the diffusing plate, which in turn improves the brightness of the display device.

### CROSS-REFERENCE TO RELATED APPLICATIONS

The present application claims the benefit of and priority to Korean patent application No. 2004-0108165 filed in the Korean Intellectual Property Office on Dec. 17, 2004, the contents of which are herein incorporated by reference in their entirety.

### BACKGROUND OF THE INVENTION

1. Field of the Invention

The present invention relates to a diffusing plate providing improved brightness, and a backlight assembly and a display device including the same, and more particularly, to a diffusing plate which amplifies light using a photoactive organic medium to improve the brightness, and a backlight assembly and a display device including the same.

2. Description of the Related Art

Recently, based on rapidly developing semiconductor technology, the demand for liquid crystal display (LCD) devices of improved performance, having a reduced size and weight, has increased exponentially.

An LCD device has become gradually more attractive as a replacement for overcoming the defects of existing cathode ray tubes (CRTs) and is currently incorporated in substantially all information processing apparati having an integrated display device, such as laptop computers, because of its reduced size, light weight, and low power consumption.

A typical LCD device applies a voltage to liquid crystal molecules to change their alignment, which changes their optical properties, such as birefringence, optical rotation, dichroism and optical scattering. The LCD device is a light receiving display device for displaying information using modulation of the light due to the orientation or alignment of liquid crystal molecules.

When an LCD device is implemented in a television, a plurality of lamps are used for realizing an image. However, there is a problem that a bright line can appear in the displayed image since a plurality of lamps are used. Also, a dark area may occur due to the space between the lamps. Accordingly, a diffusing plate disposed above the lamps can be thickened or the space between the lamps can be enlarged to ensure a uniformity of light. But these approaches may correspondingly reduce display brightness.

In a general diffusing plate, a chip made of a polymer resin is heated, injection molded, and cut using an extruding line having a thickness of 2mm to 3mm. The diffusing plate including one to three layers is then made, for example, by mixing polymer resin with light diffusing agents such as Si or CaCO₃. However, in this case, the transmissivity of the diffusing plate is deteriorated due to the light diffusing agent contained therein. Thus, the transmissivity of the diffusing plate is at most about 65%.

### SUMMARY OF THE INVENTION

The invention provides a diffusing plate which can amplify incident light to improve brightness.

The invention discloses a diffusing plate including a matrix having polymer resin, a light diffusing agent dispersed in the matrix to diffuse incident light, and an organic pigment dispersed in the matrix to activate the incident light.

The invention also discloses a backlight assembly including a light source for supplying light, and a diffusing plate for diffusing the light supplied from the light source. The diffusing plate includes a matrix having polymer resin, a light diffusing agent dispersed in the matrix to diffuse incident light, and an organic pigment dispersed in the matrix to activate the incident light.

The invention further discloses a display device including a panel unit for displaying an image, a light source for supplying light to the panel unit, and a diffusing plate for diffusing the light supplied from the light source. The diffusing plate includes a matrix having polymer resin, a light diffusing agent dispersed in the matrix to diffuse incident light, and an organic pigment dispersed in the matrix to activate the incident light.

### BRIEF DESCRIPTION OF THE DRAWINGS

The above and other features and advantages of the present invention will become more apparent by describing in detail exemplary embodiments thereof with reference to the attached drawings.

FIG. 1 is a perspective view of a diffusing plate according to an embodiment of the present invention.

FIG. 2 is an exploded perspective view of a backlight assembly provided with a diffusing plate according to an embodiment of the present invention.

FIG. 3 is an exploded perspective view of another backlight assembly provided with a diffusing plate according to an embodiment of the present invention.

FIG. 4 is an exploded perspective view of yet another backlight assembly provided with a diffusing plate according to an embodiment of the present invention.

FIG. 5 is an exploded perspective view of a display device provided with a diffusing plate according to an embodiment of the present invention.

### DETAILED DESCRIPTION OF THE EMBODIMENTS

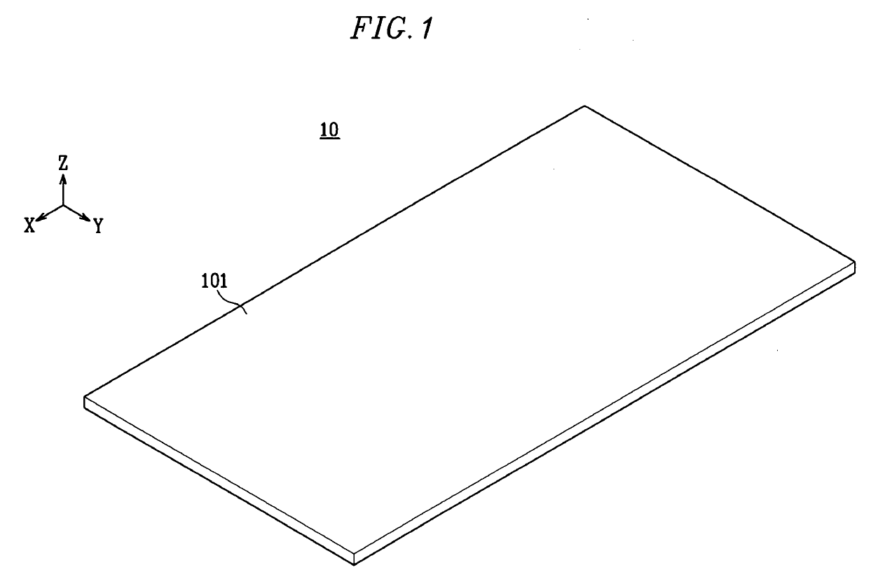

The embodiments of the present invention will now be described more fully with reference to FIGS. 1 through 5. The embodiments described herein are meant to be illustrative to like elements throughout and not restrictive. Like numbers will refer like elements throughout the detailed description.

FIG. 1 shows a diffusing plate 10 containing an organic pigment which activates the incident light.

The diffusing plate 10 shown in FIG. 1 includes a matrix 101 made of polymer resin, a light diffusing agent (not shown) that is dispersed in the matrix 101 in order to diffuse the incident light, and an organic pigment (not shown) that is dispersed in the matrix 101 in order to activate the incident light. The organic pigment is a photoactive medium and amplifies the light incident to the diffusion plate 10, thereby improving the brightness thereof.

The organic pigment can be selected from the group consisting of rhodamine organic pigment, phosphorous organic pigment, or other organic pigments, can be used. The organic pigment comprises about 0.001 ppm to about 1500.0 ppm of the diffusing plate 10. If organic pigment comprises less than about 0.001 ppm, the light amplifying effect is insignificant, and thus brightness is not improved. On the contrary, if the organic pigment comprises more than about 1500.0 ppm, the brightness is significantly improved, but the uniformity of the light is deteriorated.

The rhodamine organic pigment may be rhodamine B, rhodamine 6G, and rhodamine 19 perchlorate or a combination thereof.

The phosphorous organic pigment may be coumarin 120 and coumarin 2, or even a combination thereof.

The other organic pigments can be, for example, an organic pigment selected from the group of carbostyril 124, fluorescein, cryptocyanine, Europium tristifluoroacetylacetone (Eu(TFA)₃), Europium trishexafluoroacetylacetone (Eu(HFA)₃), neodymium trisfluoroacetylacetone, or oxamine 4 perchlorate. These organic pigments can be used alone or in combination with one another.

The polymer resin constituting the matrix 101 may be polymethyl metaacrylate (PMMA), polymethyl metaacrylate-styrene, polycarbonate, cycloolefin, or polyethyleneterephthalate. A single polymer resin or a combination of polymer resins may be used for forming the matrix 101.

The light diffusing agent is mixed and dispersed in the diffusing plate 10 and may comprise between about 0.001 ppm and about 30.0 ppm of the matrix 101. If the light diffusing agent comprises less than about 0.001 ppm, the light is not diffused well. But if the light diffusing agent comprises more than about 30.0 ppm, the light is excessively diffused and thus is not transmitted well.

The light diffusing agent may be, for example, an Si compound, CaCO₃, of talc used either alone, or in combination with one another. By mixing the light diffusing agent in the diffusion plate 10 during its manufacture, the light incident to the diffusing plate 10 can be uniformly diffused.

The diffusing plate 10 may be manufactured through the following steps.

First, raw materials are supplied by removing particulates from a package containing chip-shaped polymer resins in a clean room. Next, the package is removed and the chip-shaped polymer resins are injected into a hopper and then dried. Subsequently, the chip-shaped polymer resins are heated and the light diffusing agents and the organic pigments of an appropriate amount are mixed therewith. The polymer resins are injection molded by adjusting the rolling speed of an extruder, using an appropriate temperature and pressure. The diffusing plate may be manufactured by laminating several layers of extruded materials. Since the injection molded polymer resins are hot, the diffusing plate has fluidity. Therefore, the thickness of the diffusing plate is adequately adjusted by adjusting the rolling speed and temperature of the extruder.

The rolled diffusing plate is then cooled. Herein, the diffusing plate is placed in a room to be dried for one hour at room temperature. Also, any particulates adhered to the surface of the diffusing plate are removed by a particulates detecting system. A protective film is disposed on the surface of the diffusing plate in order to protect it. The manufactured diffusing plate can then be cut to an appropriate size. The diffusing plate is checked for whether there are any defects therein following which the diffusing plates are laminated and preserved.

Through the above-described process, a diffusing plate as shown in FIG. 1 can be manufactured. Since the diffusing agent and organic pigment dispersed in the diffusing plate 10 can be well mixed with the polymer resins in the process of injection molding, it is relatively simple to manufacture.

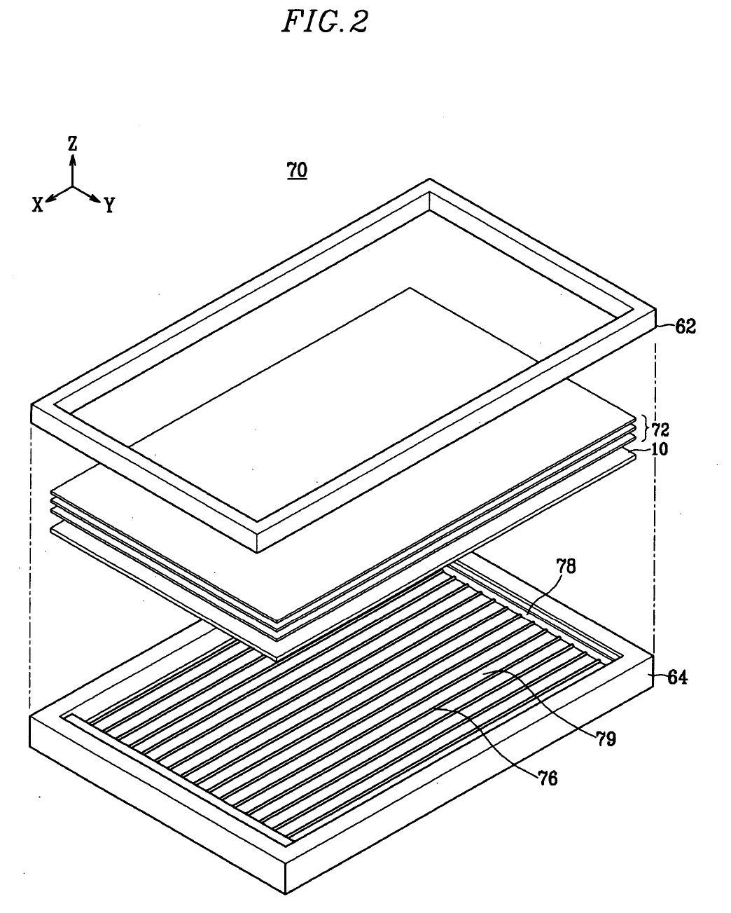

Looking at FIG. 2, the backlight assembly 70 may include optical sheets 72, a diffusing plate 10, and a lamp 76 as a light source. The backlight assembly 70 uniformly diffuses the light emitted from the lamp 76 to emit the light in an upper direction (Z-axis direction). A bottom chassis 64 receives a plurality of lamps 76, a lamp holder (not shown), and a reflecting sheet 79. A frame mold side 78 extended in the Y-axis direction covers and fixes the lamp holder. A mold frame 62 can be coupled to the bottom chassis 64, thereby forming the backlight assembly 70.

In FIG. 2, the lamp is shown as the light source, but a light emitting diode (LED) or a linear light source may also be used, for example.

The plurality of lamps 76 for supplying the light are fixed on the bottom chassis 64 parallel to one another at a predetermined separation distance. The reflecting sheet 79 is provided on the bottom surface of the bottom chassis 64 and reflects the light emitted from the plurality of lamps 76, which may be cold cathode fluorescent lamps (CCFL). The lamp holder is provided at the end of the plurality of lamps 76, thereby fixing and supporting the plurality of lamps 76.

The light emitted from the plurality of lamps 76 is uniformly diffused in passing through the diffusing plate 10. The diffusing plate 10 also amplifies light having a wavelength from about 200 nm to about 800 nm emitted from the plurality of lamps 76. Therefore, the light is not only well-diffused but also its brightness is improved. If its wavelength is less than about 200 nm, the brightness of the light may not be improved even if the light is diffused well. Also, if its wavelength is greater than about 800 nm, it is desirable for the light to be transmitted as it is, due to its large wavelength, rather than, diffused. Therefore, the brightness of the light passing through diffusing plate 10 can be improved.

The optical sheets 72 that can be disposed above the diffusing plate 10 to improve the brightness of the light is supplied to the upper side of the backlight assembly 70. Therefore, the backlight assembly can supply uniform light with high brightness.

An inverter (not shown) can be provided on the rear surface of the bottom chassis 64 that transforms an external voltage to provide a transformed voltage to the plurality of lamps 76 for emitting light therefrom.

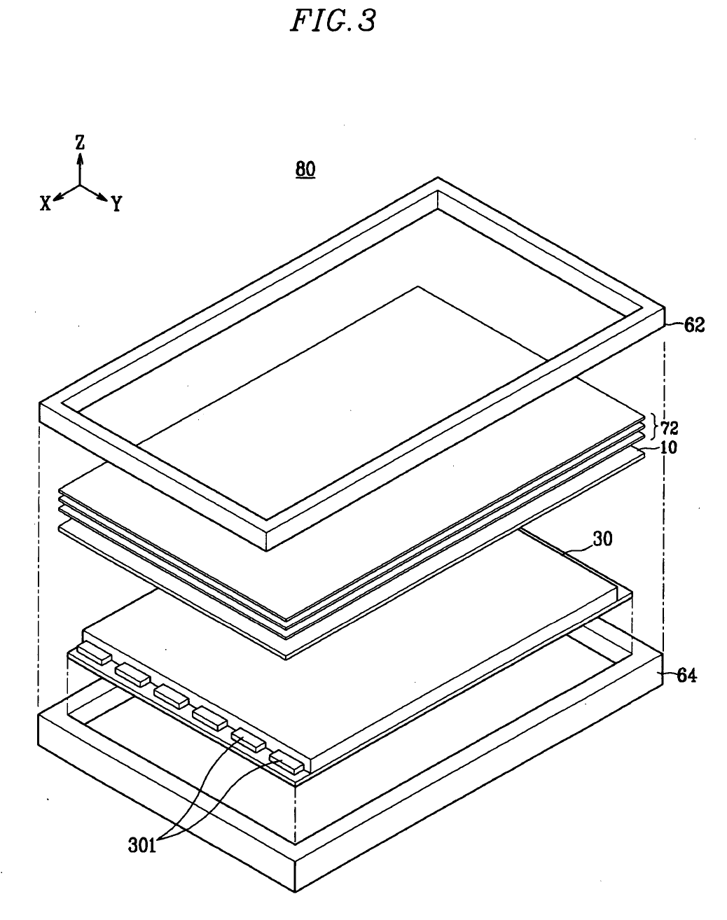

FIG. 3 shows a backlight assembly 80 provided with a planar light source 30.

The planar light source 30 provided with a partitioning wall (not shown) inside is integrally assembled. The planar light source 30 emits electrons through a plurality of electrodes 301 provided on both ends thereof. The emitted electrons excite a discharging gas enclosed in the planar light source 30, thereby emitting light towards the upper side in the Z-axis direction. An inert gas such as Xe or Ar can be used as the discharging gas, which may be excited by the electrons to emit ultraviolet rays. The ultraviolet rays collide with a phosphor layer coating in the planar light source 30 to generate visible rays. The phosphor layer uniformly includes material which generates red (R), green (G) and blue (B) light when struck by the ultraviolet rays. Accordingly, white light is emitted as soon as the electrons collide with the ultraviolet rays. A reflecting layer is provided below the planar light source 30 to reflect white light headed to the lower side towards the upper side.

The light emitted from the planar light source 30 by the above-mentioned procedure is uniformly diffused by the diffusing plate 10 and is supplied to the upper side to thereby improve brightness. Accordingly, uniformly diffused light having improved brightness can be obtained.

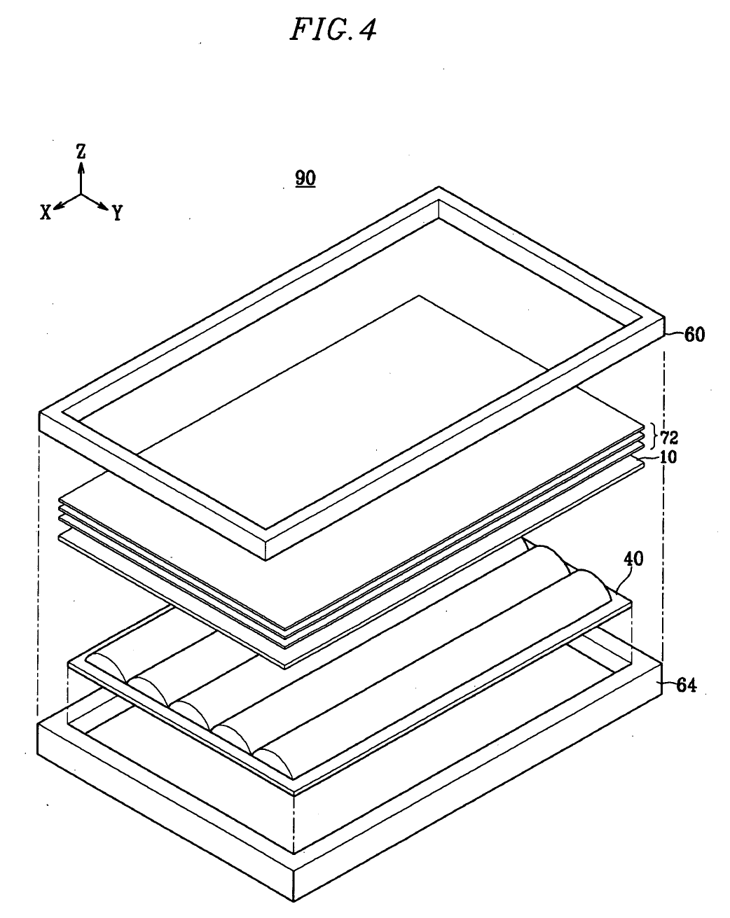

FIG. 4 shows a backlight assembly 90 including another planar light source 40.

An electrode is provided in the planar light source 40, and electrons emitted from the electrode excite discharging gas enclosed therein, to supply light. A plurality of the planar light sources 40 are arranged along the Y-axis direction for separately supplying light. The outside of the planar light source 40 may be made of metal and the lower portion thereof may be made of a glass substrate. In the planar light source 40, an electrode, a phosphor layer, and a reflecting layer can be formed.

Accordingly, the discharging gas is excited by the electrons emitted from the electrode to generate the visible rays from the phosphor layer. The diffusing plate 10 is disposed on the upper side of the planar light source 40, thereby diffusing the light supplied from the lower side while simultaneously improving its brightness to supply the light to the upper side. The diffusing sheet 72 may further improve the brightness of the light supplied to the upper side.

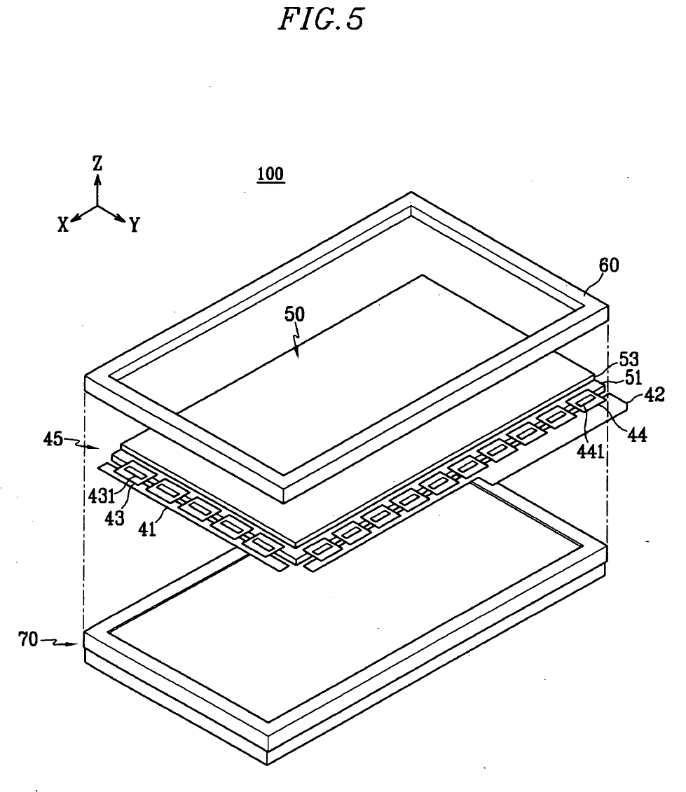

FIG. 5 shows a display device 100 provided with the backlight assembly 70 shown in FIG. 2.

An LCD panel assembly 45 may include, for example, an LCD panel 50, driver integrated circuit (IC) packages 43 and 44 connected to the LCD panel 50 for supplying driving signals thereto, and printed circuit boards (PCBs) 41 and 42. The driver IC packages may include a chip on film (COF) or a tape carrier package (TCP). The PCBs 41 and 42 can be received at the side of the top chassis 60.

The LCD panel 50 may include a TFT panel 51 made of a plurality of thin film transistors (TFT), a color filter panel 53 disposed on the TFT panel 51, and liquid crystal layer (not shown) injected therebetween. Polarizers attached to the upper surface of the color filter panel 53 and the lower surface of the TFT panel 51 polarize the light passing through the LCD panel 50.

The TFT panel 51 is a transparent glass panel in which TFTs are formed in a matrix. A source terminal is connected with a data line and a gate terminal is connected with a gate line. Also, a drain terminal is formed with a pixel electrode made of transparent indium tin oxide (ITO) as a conductive material.

The TFT is turned on or off in accordance with electrical signals input through the PCBs 41 and 42 to the gate lines and data lines formed on the LCD panel 50 and then the electrical signals required for forming a pixel are output to the drain terminal.

Meanwhile, a color filter panel 53 is disposed on the TFT panel 51. The color filter panel 53 is formed with RGB pixels by a thin film forming process and is coated with a common electrode made of ITO on the overall surface thereof. The RGB pixels are color pixels that exhibit predetermined colors by the passing of light therethrough. If a voltage is applied to the gate terminal and the source terminal of the TFT to turn on the thin film transistor, an electric field is formed between the pixel electrode and the common electrode of the color filter panel. Due to the electric field, the alignment angle of the liquid crystal molecules between the TFT panel 51 and the color filter panel 53 is changed to thereby change the light transmissivity thereof obtaining a desired image.

The PCBs 41 and 42 receive video signals from the outside of the LCD panel 50 and apply driving signals to the gate lines and the data lines. The PCBs 41 and 42 are connected with the driver IC packages 43 and 44 attached to the LCD panel 50. In order to drive the display device 100, the gate PCB 41 generates a gate driving signal and the data PCB 42 generates a data driving signal. Also, the gate driving signal, the data driving signal, and a plurality of driving signals for applying those signals at appropriate times are generated. The gate driving signal and the data driving signal are applied to the gate line and the data line of the LCD panel 50 through the driving IC packages 43 and 44, respectively, on which IC chips 431, 441 are mounted. A control board (not shown) is mounted on the rear surface of the backlight assembly 70. The control board is connected to the data PCB 42, and converts an analog data signal into a digital data signal, which is then supplied to the LCD panel 50.

The LCD panel 50 is fixed on the backlight assembly 70 using a top chassis 60.

In the display device 100, since uniform light with improved brightness is supplied from the backlight assembly 70, a high definition image can be realized by the LCD panel 50.

Hereinafter, the present invention will be more fully described by experimental examples. The experimental examples only illustrate the present invention, which should not be viewed as being limited to these examples.

### Experimental Examples

A diffusing plate was made by mixing the organic pigment with PMMA in which the light diffusing agent is also mixed. After manufacturing a 42-inch backlight assembly according to the invention, a voltage was applied to the light source. The brightness was measured at nine points of the backlight assembly. A BM7 optical measurer was used to measure the brightness. The diffusing plate was manufactured by mixing PMMA, an Si compound, and four different kinds of organic pigments as listed below.

### Experimental Example 1

The organic pigment comprises about 400 ppm of oxamine 4 perchlorate and about 100 ppm of coumarin 120. Thus, the diffusing plate was made using a total of about 500 ppm of organic pigments.

### Experimental Example 2

The organic pigment comprises about 500 ppm of rhodamine B, and about 700 ppm of Eu (TFA)₃. Thus, the diffusing plate was made using a total of about 1200 ppm of organic pigments.

### Experimental Example 3

The organic pigment comprises about 700 ppm of rhodamine B, and about 800 ppm of Eu (HFA)₃. Accordingly, the diffusing plate was made using a total of about 1500 ppm of organic pigments.

### Experimental Example 4

The organic pigment comprises about 300 ppm of oxamine 4 perchlorate, about 50 ppm of coumarin 120, about 600 ppm of Eu (HFA)₃, and about 200 ppm of rhodamine B. Therefore, the diffusing plate was made using a total of about 1150 ppm of organic pigments.

### Comparative Example

For comparison with the diffusing plates made according to the present invention, a well-known diffusing plate using only PMMA and an Si compound was made.

The brightness (cd/m²) was subsequently measured at 9 points of the backlight assemblies made according to the above-described experimental examples 1 to 4 and the comparative example, and were as follows:

TABLE 1

| | EXPERIMENTAL | EXPERIMENTAL | EXPERIMENTAL | EXPERIMENTAL | COMPARATIVE |
|---|---|---|---|---|---|
| LOCATION | EXAMPLE 1 | EXAMPLE 2 | EXAMPLE 3 | EXAMPLE 4 | EXAMPLE |
| 1 | 8805 | 8657 | 8231 | 8112 | 7805 |
| 2 | 8813 | 8641 | 7860 | 8342 | 7813 |
| 3 | 8481 | 8641 | 8213 | 8432 | 8481 |
| 4 | 8841 | 7898 | 8543 | 8167 | 7841 |
| 5 | 8029 | 8432 | 8200 | 8453 | 8029 |
| 6 | 8645 | 8111 | 8300 | 8511 | 7645 |
| 7 | 8777 | 8564 | 8543 | 8611 | 7777 |
| 8 | 8881 | 8790 | 8231 | 8341 | 7881 |
| 9 | 8669 | 8213 | 8621 | 8333 | 7669 |
| AVERAGE | 8660 | 8418 | 8304 | 8367 | 7771 |

As can be seen from Table 1, the brightness of the diffusing plate using the organic pigment is greater than that of the diffusing plate without the organic pigment. That is, high brightness can be obtained in the experimental examples 1 through 4 relative to the comparative example. The brightness is improved by mixing an appropriate amount of the organic pigment with the diffusing plate and thus a high definition image can be realized.

Although the embodiments of the invention have been described, the present invention is not limited to the above-described embodiments, but may be modified in various forms without departing from the scope of the appended claims, the detailed description, and the accompanying drawings of the present invention.

What is claimed is:

1. A diffusing plate, comprising:
a matrix including polymer resin;
a light diffusing agent dispersed in the matrix to diffuse incident light; and
an organic pigment dispersed in the matrix to activate the incident light.

2. The diffusing plate of claim 1, wherein the organic pigment comprises at least one organic pigment selected from the group consisting of:
rhodamine organic pigment,
phosphorous organic pigment,
carbostyril 124,
fluorescein,
cryptocyanine,
Europium tristifluoroacetylacetone (Eu(TFA)₃),
Europium trishexafluoroacetylacetone Eu(HFA)₃),
neodymium trisfluoroacetylacetone, and
oxamine 4 perchlorate.

3. The diffusing plate of claim 2, wherein the rhodamine organic pigment is at least one organic pigment selected from the group consisting of:
rhodamine B,
rhodamine 6G, and
rhodamine 19 perchlorate.

4. The diffusing plate of claim 2, wherein the phosphorous organic pigment is at least one organic pigment selected from the group consisting of coumarin 120 and coumarin 2.

5. The diffusing plate of claim 1, wherein the diffusing plate comprises about 0.001 ppm to about 1500.0 ppm of the organic pigment dispersed in the matrix.

6. The diffusing plate of claim 1, wherein the polymer resin comprises at least one polymer resin selected from the group consisting of:
polymethyl metaacrylate (PMMA),
polymethyl metaacrylate-styrene,
polycarbonate,
cycloolefin, and
polyethyleneterephthalate.

7. The diffusing plate of claim 1, wherein the diffusing plate comprises about 0.001 ppm to about 30.0 ppm of the light diffusing agent dispersed in the matrix.

8. The diffusing plate of claim 7, wherein the light diffusing agent comprises at least one light diffusing agent selected from the group consisting of:
an Si compound,
CaCO₃, and
talc.

9. A backlight assembly, comprising:
a light source for supplying light; and
a diffusing plate for diffusing the light supplied from the light source, wherein the diffusing plate comprises:
a matrix including polymer resin,
a light diffusing agent dispersed in the matrix to diffuse incident light from the light source, and
an organic pigment dispersed in the matrix to activate the incident light.

10. The backlight assembly of claim 9, wherein the organic pigment comprises at least one organic pigment selected from the group consisting of:
rhodamine organic pigment,
phosphorous organic pigment,
carbostyril 124,
fluorescein,
cryptocyanine,
Europium tristifluoroacetylacetone (Eu(TFA)₃),
Europium trishexafluoroacetylacetone (Eu(HFA)₃),
neodymium trisfluoroacetylacetone, and
oxamine 4 perchlorate.

11. The backlight assembly of claim 10, wherein the rhodamine organic pigment is at least one organic pigment selected from the group consisting of:
rhodamine B,
rhodamine 6G, and
rhodamine 19 perchlorate.

12. The backlight assembly of claim 10, wherein the phosphorous organic pigment is at least one organic pigment selected from the group consisting of coumarin 120 and coumarin 2.

13. The backlight assembly of claim 9, wherein the diffusing plate comprises about 0.001 ppm to about 1500.0 ppm of the organic pigment dispersed in the matrix.

14. The backlight assembly of claim 9, wherein the polymer resin comprises at least one polymer resin selected from the group consisting of:
polymethyl metaacrylate (PMMA),
polymethyl metaacrylate-styrene,
polycarbonate,
cycloolefin, and
polyethyleneterephthalate.

15. The backlight assembly of claim 9, wherein the diffusing plate comprises about 0.001 ppm to about 30.0 ppm of the light diffusing agent dispersed in the matrix.

16. The backlight assembly of claim 15, wherein the light diffusing agent comprises at least one light diffusing agent selected from the group consisting of:
an Si compound,
CaCO₃, and
talc.

17. The backlight assembly of claim 9, wherein the light source comprises a plurality of lamps which are arranged parallel to each other.

18. The backlight assembly of claim 11, wherein the light source comprises a planar light source including an electrode and having a discharging gas enclosed,
wherein electrons emitted from the electrode excite the discharging gas to supply the light.

19. The backlight assembly of claim 18, wherein a plurality of the planar light sources are arranged parallel to each other and each planar light source separately supplies light.

20. The backlight assembly of claim 9, wherein the diffusing plate amplifies the light emitted from the light source having a wavelength from about 200 nm to about 800 nm.

21. A display device, comprising:
a panel unit for displaying an image;
a light source for supplying light to the panel unit; and
a diffusing plate for diffusing the light supplied from the light source,
wherein the diffusing plate comprises:
a matrix made of polymer resin,
a light diffusing agent dispersed in the matrix to diffuse incident light, and
organic pigment dispersed in the matrix to activate the incident light.

22. The display device of claim 21, wherein the panel unit comprises a liquid crystal display panel.
